(19) United States
(12) Patent Application Publication
(10) Pub. No.: US 2012/0315854 A1
(43) Pub. Date: Dec. 13, 2012

(54) MOBILE DEVICE WITH ANTENNA SYSTEM

(75) Inventor: XIANG CAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/217,671

(22) Filed: Aug. 25, 2011

(30) Foreign Application Priority Data
Jun. 9, 2011 (CN) 201110153755.1

(51) Int. Cl. H04B 7/00

(52) U.S. Cl. 455/41.3

(57) ABSTRACT

A mobile device includes a main body and a headset. The main body includes a microprocessor, a radio frequency unit, a base-band unit connected between the microprocessor and the radio frequency unit, and a headset interface connected to the microprocessor by an audio signal line and connected to the radio frequency unit by a radio frequency signal line. The headset includes a plug to be plugged into the headset interface. An external antenna and a headset module are set in the headset and connected to the plug. The radio frequency unit is used to send radio signals to the external antenna and receive radio signals form the external antenna through the plug and the headset interface.

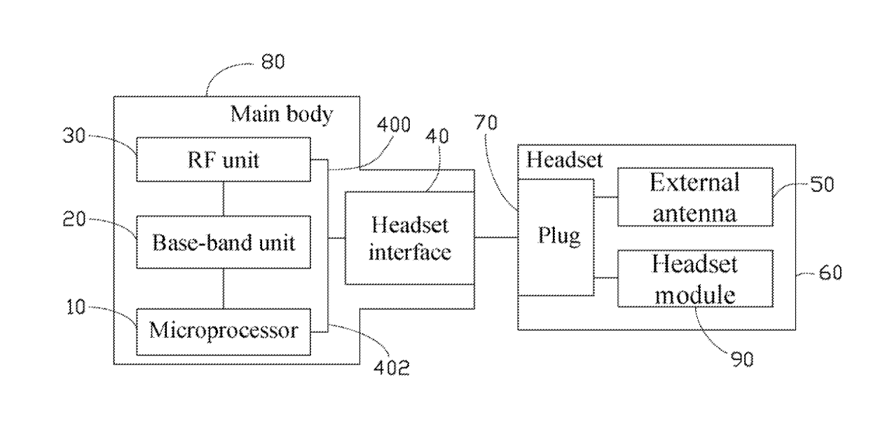

### BACKGROUND

1. Technical Field

The present disclosure relates to a mobile device with an antenna system.

2. Description of Related Art

Many mobile devices, such as mobile phones, have built-in antennae to send and/or receive signals. Give their size, the built-in antennae are only effective with signals above a certain strength. To allow the mobile device to pick up relatively weaker signals, an additional interface may be added for connecting an external antenna. However, for relatively small mobile devices, the additional interface occupies valuable real estate and may reduce further miniaturization. Therefore there is room for improvement in the art.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments.

The figure is a block diagram of an exemplary embodiment of a mobile device with an antenna system.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the figure, an exemplary embodiment of a mobile device, such as a mobile phone, includes a main body 80 and a headset 60. The main body 80 includes a microprocessor 10, a base-band unit 20, a radio frequency (RF) unit 30, and a headset interface 40. The headset 60 includes a plug 70, an external antenna 50, and a headset module 90.

The base-band unit 20 is connected between the microprocessor 10 and the RF unit 30. The headset interface 40 is connected to the microprocessor 10 through an audio signal line 402, and is connected to the RF unit 30 through an RF signal line 400. The headset module 90 is connected to the plug 70. The external antenna 50 is set in the headset 60 and connected to the plug 70. The external antenna 50 is connected to the RF unit 30 when the plug 70 is plugged into the headset interface 40. The headset module 90 executes the function of playing sound.

In use, the plug 70 is plugged into the headset interface 40. In the process of sending radio signals, the microprocessor 10 controls the base-band unit 20 to produce baseband signals and transmit the baseband signals to the RF unit 30. The RF unit 30 modulates the baseband signals to RF signals, and transmits the RF signals to the external antenna 50 through the headset interface 40 and the plug 70. After that, the external antenna 50 transmits the RF signals to a base station that is used to communicate with other mobile devices. During receiving radio signals, the external antenna 50 receives RF signals form the base station, and transmits the received RF signals to the RF unit 30 through the plug 70 and the headset interface 40. The RF unit 30 reduces the RF signals to the baseband signals by demodulation, and transmits the baseband signals to the base-band unit 20. The microprocessor 10 then controls the base-band unit 20 to process the baseband signals.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A mobile device comprising:
a main body comprising a microprocessor, a radio frequency (RF) unit, a base-band unit connected between the microprocessor and the RF unit, and a headset interface connected to the microprocessor though an audio signal line and connected to the RF unit though an RF signal line; and
a headset comprising a plug to be plugged into the headset interface, and an external antenna and a headset module both set in the headset and connected to the plug;
wherein the radio frequency unit is used to send radio signals to the external antenna and receive radio signals form the external antenna through the plug and the headset interface.
